(19) United States
(12) Patent Application Publication
(10) Pub. No.: US 2026/0112393 A1
(43) Pub. Date: Apr. 23, 2026

(54) MULTI-MODE HARD DISK DRIVE RECIRCULATION FILTER SYSTEM

(71) Applicant: Western Digital Technologies, Inc., San Jose, CA (US)

(72) Inventors: Jon Garbarino, San Jose, CA (US); Andre Chan, Palo Alto, CA (US)

(21) Appl. No.: 18/922,339

(22) Filed: Oct. 21, 2024

(51) Int. Cl. G11B 33/14

(52) U.S. Cl. CPC G11B 33/146

(57) ABSTRACT

A multi-mode recirculation filter for a hard disk drive (HDD) includes a housing for filtration media, including first ribs having a first distance therebetween and extending from a disk side toward the filtration media, a first plenum on an opposing side of the filtration media behind the first ribs and having a closed back side, and a flow path for receiving flow into the plenum, all enabling pressure reduction on the disk side to maximize the pressure drop across the filter while a head stack assembly (HSA) is parked on a ramp. Housing further includes second ribs downstream of the first ribs, having a second distance therebetween greater than the first distance, and a second plenum behind the second ribs and having an open back side, all enabling increased pressure on the disk side in conjunction with the pressure generated by the HSA while loaded on a disk stack.

### FIELD OF EMBODIMENTS

Embodiments of the invention may relate generally to hard disk drives, and particularly to approaches to a recirculation filter system configured for effectiveness and efficiency across the full operational spectrum of head stack assembly (HSA).

### BACKGROUND

A hard disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read-write head (also referred to as a “transducer”) housed in a slider that is positioned over a specific location of a disk by an actuator. A read-write head makes use of magnetic fields to write data to and read data from the surface of a magnetic-recording disk. A write head works by using the current flowing through its coil to produce a magnetic field. Electrical pulses are sent to the write head, with different patterns of positive and negative currents. The current in the coil of the write head produces a localized magnetic field across the gap between the head and the magnetic-recording disk, which in turn magnetizes a small area on the recording medium.

Because the recording disks spin within an HDD during operation, gas (air, helium, etc.) flow is generated. Indeed, the air bearing slider (or, generally, gas bearing slider) on which a read-write head is housed relies on such gas flow in order to fly over a disk in order to function as purposed. However, small airborne particles may adhere to the air bearing surfaces of a read-write head or may deposit on a surface of a disk. When an airborne particle attaches to the surface of either a read-write head or a disk, the head may not read data properly or may scrape across the surface of a disk which could grind away the thin magnetic film of the disk and cause data loss and potentially render the HDD inoperable. During the manufacturing process, airborne particles may be introduced into the interior of the enclosure of the HDD. Additionally, during operation certain parts within the interior of the HDD may contact each other in a manner that causes airborne particles to be released.

To remove airborne particles from the interior of a HDD, an airborne particle filter (also referred to as a “recirculation filter”) may be installed within the interior of the enclosure, as well as a “breather filter” around a passage in the enclosure used to equalize the pressure between the interior and the exterior of the enclosure. These filters are typically situated in a flow caused by rotation of the disks. As the gas flows through these filters, particles carried by the gas may become trapped in the filter, thereby cleaning the air. As the amount of gas flowing through an airborne particle filter increases, the number of airborne particles trapped by the filter will likewise increase. However, use of gases lighter than air in the interior of an HDD can negatively impact the performance of filtration because there is less of a pressure differential produced across these types of filters.

Any approaches that may be described in this section are approaches that could be pursued, but not necessarily approaches that have been previously conceived or pursued.

Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2A is a plan view illustrating an HDD comprising a spoiler;

FIG. 2B is a perspective view illustrating the spoiler of FIG. 2A;

FIG. 3A is an exploded perspective view illustrating a backflow recirculation filter for an HDD, according to an embodiment;

FIG. 3B is a perspective view illustrating the installed backflow recirculation filter of FIG. 3A, according to an embodiment;

FIG. 4 is a top view pressure diagram illustrating a 7-cavity aspect ratio for a backflow recirculation filter, according to an embodiment;

FIG. 5A is an exploded perspective view illustrating a multi-mode recirculation filter for an HDD, according to an embodiment;

FIG. 5B is a perspective view illustrating the installed multi-mode recirculation filter of FIG. 5A, according to an embodiment;

FIG. 6A is a top view illustrating functionality of a multi-mode recirculation filter with head stack assembly (HSA) parked on the load/unload ramp, according to an embodiment;

FIG. 6B is a top view illustrating functionality of the multi-mode recirculation filter of FIG. 6A with HSA loaded on the disk, according to an embodiment;

FIG. 7A is a perspective view illustrating a multi-mode recirculation filter, according to an embodiment;

FIG. 7B is a front view illustrating the multi-mode recirculation filter of FIG. 7A, according to an embodiment;

FIG. 7C is a top view illustrating the multi-mode recirculation filter of FIG. 7A, according to an embodiment;

FIG. 7D is a side view illustrating the multi-mode recirculation filter of FIG. 7A, according to an embodiment;

FIG. 7E is a bottom view illustrating the multi-mode recirculation filter of FIG. 7A, according to an embodiment;

FIG. 7F is a cross-sectional view A-A illustrating the multi-mode recirculation filter of FIG. 7A, according to an embodiment; and

FIG. 7G is a cross-sectional view B-B illustrating the multi-mode recirculation filter of FIG. 7A, according to an embodiment.

### DETAILED DESCRIPTION

Generally, approaches to a hard disk drive (HDD) recirculation filter system configured for functioning across the operational spectrum of the head stack assembly (HSA) are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices may be shown in block diagram form in order to avoid unnecessarily obscuring the embodiments of the invention described herein.

### INTRODUCTION

### Terminology

References herein to “an embodiment”, “one embodiment”, and the like, are intended to mean that the particular feature, structure, or characteristic being described is included in at least one embodiment of the invention. However, instances of such phrases do not necessarily all refer to the same embodiment.

The term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the structure is vertical for all practical purposes but may not be precisely at 90 degrees throughout.

While terms such as “optimal”, “optimize”, “minimal”, “minimize”, “maximal”, “maximize”, and the like may not have certain values associated therewith, if such terms are used herein the intent is that one of ordinary skill in the art would understand such terms to include affecting a value, parameter, metric, and the like in a beneficial direction consistent with the totality of this disclosure. For example, describing a value of something as “minimal” does not require that the value actually be equal to some theoretical minimum (e.g., zero), but should be understood in a practical sense in that a corresponding goal would be to move the value in a beneficial direction toward a theoretical minimum.

### Context

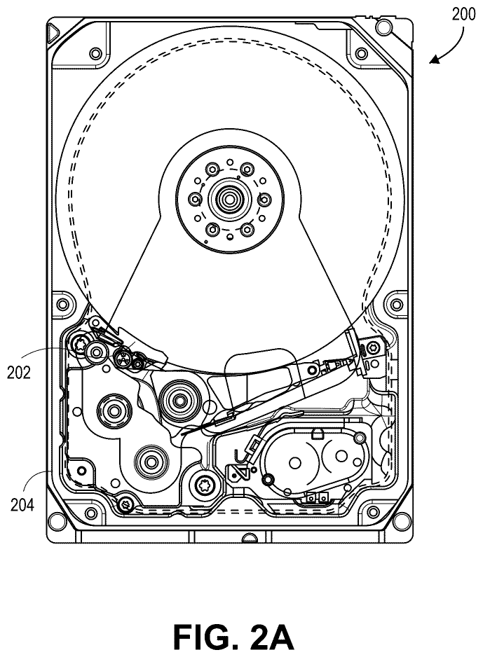

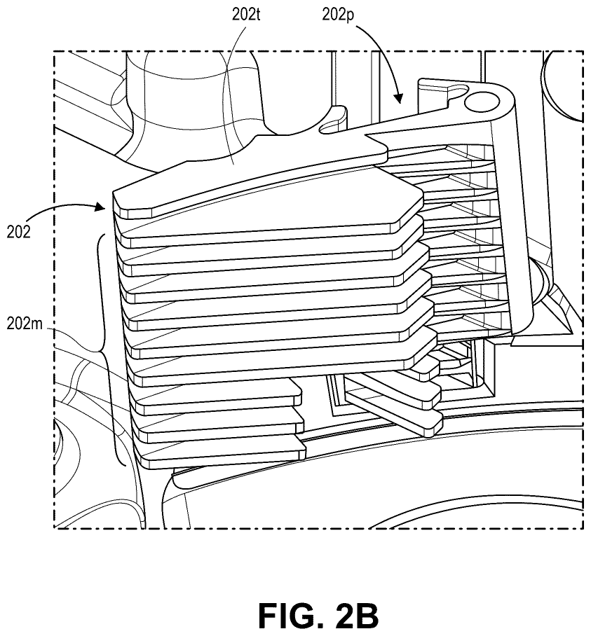

Recall that typical legacy recirculation filtration designs for hard disk drives (HDDs) rely on creating a pressure difference across a filter, and HDDs filled with helium or some other lighter-than-air gas present a unique challenge compared to air-filled drives because of the flow characteristics of the lower density helium which translates to over seven times higher kinematic viscosity. To generate an effective pressure across filter media for HDD cleanup, some filter systems have been designed with fins that protrude out into the flow stream between the spinning disks. These provide an effective barrier which redirects particle movement through the filter media. Such fins may be incorporated into a spoiler upstream from the head stack assembly (HSA), which may include an opening for an airborne particle filter. FIG. 2A is a plan view illustrating a hard disk drive (HDD) comprising a spoiler. HDD 200 comprises a spoiler 202 installed in an enclosure base 204.

FIG. 2B is a perspective view illustrating the spoiler of FIG. 2A. This view shows the shape of a top fin 202t of spoiler 202, as well as the shapes of multiple middle fins 202m of the spoiler 202, which are interposed between adjacent disks of a disk stack (removed here for clarity). FIG. 2B further illustrates the presence of a filter pocket 202p of spoiler 202, which is configured to house an airborne particle filter (not shown).

When an upstream spoiler purposefully diverts the flow of gas from the head slider, the spoiler creates an area of relatively greater pressure in the flow of gas preceding the spoiler. Gas in the area of greater pressure flows through the airborne particle filter to an area of relatively lesser pressure, thereby removing airborne particles from the flow within the enclosure of the HDD. There are two distinct undesirable effects associated with attempting to clean up airborne particles using this approach. The first effect is that having fins between the disks results in unwanted aerodynamic drag which increases spindle motor power consumption. The second effect is that this approach to redirecting particles is not completely effective in forcing them to be captured by the filter media. Particle collection experiments and CFD (computational fluid dynamics) analysis have shown that particles have a propensity to collect on the disk underneath the fins at a rate which is disproportionate to other observed particle deposition on the rest of the disk.

### BACKFLOW RECIRCULATION FILTER

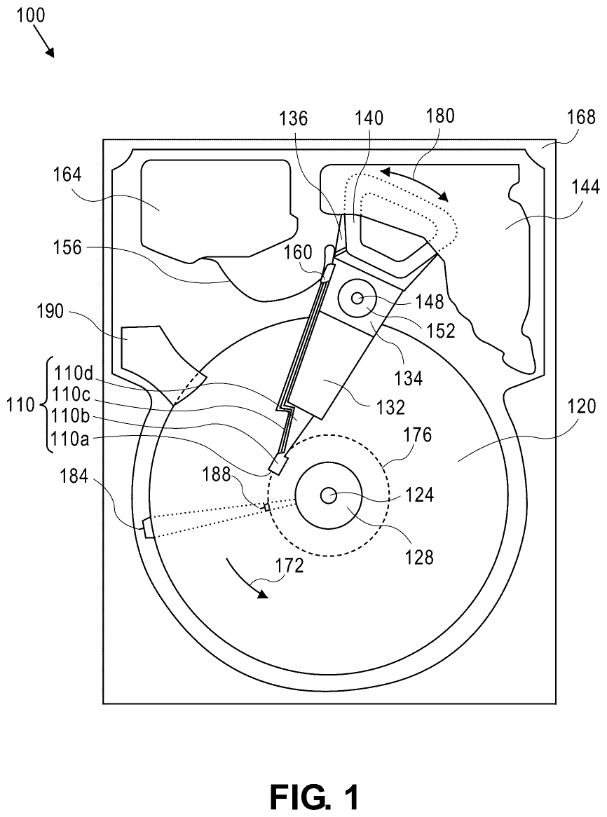

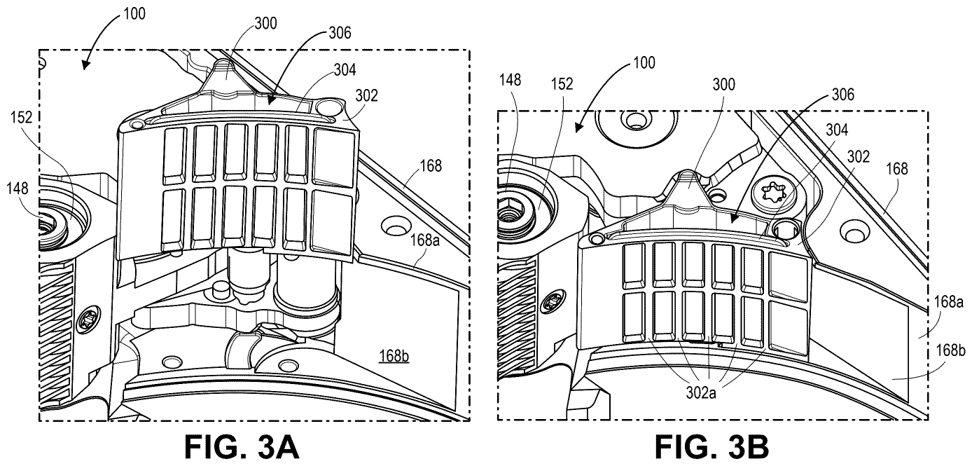

FIG. 3A is an exploded perspective view illustrating a backflow recirculation filter for an HDD, and FIG. 3B is a perspective view illustrating the installed backflow recirculation filter of FIG. 3A, both according to one or more embodiments. FIGS. 3A-3B illustrate a backflow recirculation filter relative to a conventional hard disk drive (HDD) 100 comprising disk media mounted on a spindle (not shown here; see, e.g., recording medium 120 of FIG. 1), a head slider housing a read-write transducer (not shown here; see, e.g., slider 110b that includes a magnetic read-write head 110a of FIG. 1) configured to read from and to write to a disk medium of the disk media, an actuator assembly (not shown here; see, e.g., voice coil 140 of the voice coil motor of FIG. 1) configured for moving the head slider about a pivot (see also, e.g., pivot shaft 148 with an interposed pivot bearing assembly 152 of FIG. 1) to access portions of the disk medium. These HDD components are housed in an enclosure including a base (not shown here; see, e.g., HDD housing 168 of FIG. 1).

According to an embodiment, a recirculation filter 300 (or simply “filter 300”) is positioned upstream (e.g., at a location referred to as “7 o'clock”, and in view of the medium/media 120 spinning in the direction 172 of FIG. 1) of and adjacent to the pivot shaft 148/bearing assembly 152 (simply, the “pivot”). The recirculation filter 300 comprises a housing 302 configured for housing filtration media 304, the housing 302 comprising a set of ribs 302a, having a first distance therebetween, extending from a disk-facing side of the housing 302 toward the filtration media 304. Recirculation filter 300 further comprises a plenum 306, including a closed back side, on an opposing side of the filtration media 304 behind the set of ribs 302a. According to an embodiment, the HDD enclosure 168 includes a disk shroud 168a that surrounds a majority of a perimeter of a disk stack, including upstream of the filter 300, where the disk shroud 168a includes a diverter portion 168b configured for directing gas flow into the plenum 306 of the filter 300. With this approach, the oncoming flow from the disk stack is diverted, redirected by the diverter portion 168b of the disk shroud 168a to behind the filtration media 304 and into the enclosed plenum 306 via a supply flow path of the filter 300. The filter housing 302 geometry is designed such that pressure is reduced on the disk side of the filtration media 304 relative to the plenum 306 side, which draws free particles into the filtration media 304 (e.g., mainly to the back side of the filtration media 304). Generally, and as depicted in FIGS. 3A-3B, each of the set of ribs 302a of the housing 302 comprises a substantially planar outermost disk-facing surface, and the set of ribs 302a is configured with a radius of curvature substantially equivalent to a radius of curvature of the disk media.

An HDD such as HDD 100 further comprises a head stack assembly (HSA) (see, e.g., HSA of FIG. 1) coupled with the actuator assembly and housing the head slider.

According to an embodiment, the set of ribs 302a of the housing 302 is configured, relative to the filtration media 304, to reduce pressure on the disk-facing side of the filter 300 while the HSA is parked on a load/unload ramp (not shown here; see, e.g., load/unload ramp 190 of FIG. 1). A noteworthy aspect to this approach that makes it effective is the vertical rib geometry on the front of the filter, i.e., the set of ribs 302a. The rib orientation (orthogonal to the fluid flow), height, and spacing exploit a phenomenon known as Lid Driven Cavity Flow to reduce pressure on the disk side. This reduction maximizes the pressure drop across the filter 300, which is a principal objective of maximizing fluid and particle flow through the filtration media 304.

In a classic Lid Driven Cavity Flow condition, the goal is to have consistent pressure across the cavity, here formed by the set of ribs 302a in conjunction with the filtration media 304, which is typically achieved by having a wall height to floor ratio of one (1). In the case of filter 300, the cavity floor (filtration media 304) and the walls (set of ribs 302a of housing 302) are not likely precisely perpendicular so the goal through CFD (computational fluid dynamics) is to optimize such that there is minimal pressure variation across the floor but not so small as to eliminate effective filter area. Testing and correlated results from CFD analysis have indicated that an effective wall/floor design ratio be in a range of ¼ to 1. Thus, according to an embodiment, the set of ribs 302a of the housing 302 is configured such that the ratio of a distance between each rib of the set of ribs 302a relative to a depth of those ribs 302a lies in a range of one (1) to four (4).

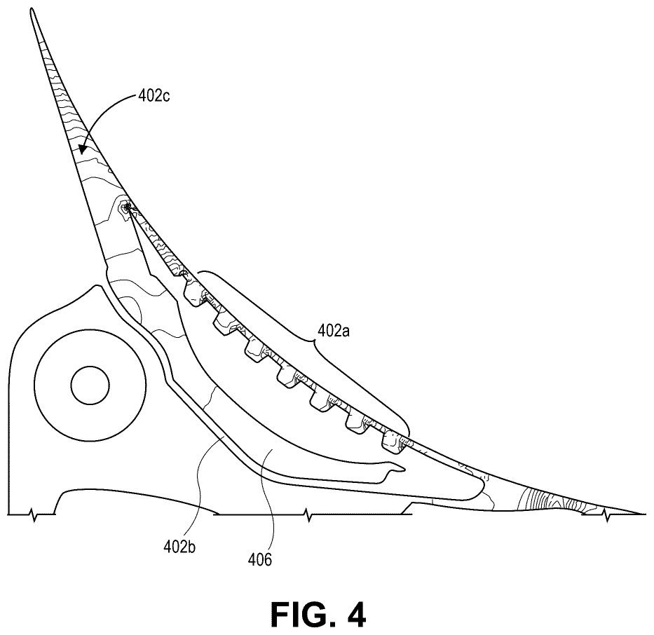

FIG. 4 is a top view pressure diagram illustrating a 7-cavity aspect ratio for a backflow recirculation filter, according to an embodiment. While the number of cavities and corresponding ribs may vary from implementation to implementation, in this non-limiting example in the context of the spatial and other constraints associated with installation of such a recirculation filter 300 at the 7 o'clock location within an HDD just upstream of the pivot, a 7-cavity arrangement (e.g., an approximately 1:1 floor/wall ratio) is considered suitable for the intended purpose. Alternative 6-cavity to 4-cavity arrangements would likely approach an approximately 4:1 floor/wall ratio and are considered suitable for the intended purpose.

Illustrated here is an example effect of the ribs 402a (7 ribs in this example) of a housing on the pressure differential across a plenum 406 (see also, e.g., plenum 306 of FIGS. 3A-3B) having a back wall 402b and behind where filtration media (not shown here; see, e.g., filtration media 304 of FIGS. 3A-3B) would be housed. CFD analysis of this model shows that the pressure from flow incoming through a supply flow path 402c and into the area of plenum 406 is around 21 Pa (Pascal) and the flow on the other side of the plenum 406 (e.g., just inside of the ribs 402a) is around 12 Pa, thus indicating that for this arrangement a pressure differential across where the filtration media would be housed of approximately 9 Pa is achievable. This inward filter flow (backflow) arrangement relies on the secondary flow that naturally draws towards the center of rotation (i.e., the spindle motor hub) and the close proximity of the back wall 402b to the filtration media to prevent flow expansion, which would otherwise cause a lower pressure differential across the filtration media.

As described elsewhere herein, previous approaches to recirculation cleanup typically require adding obstructive features such as spoilers/fins/wings to redirect flow which results in greater frictional drag on the disk stack, requiring greater power consumption to maintain motor rpm (revolutions per minute). The backflow filter approach illustrated and described herein effectively eliminates such drag-inducing features, and simulation and analysis has indicated an approximately 7-10% reduction in power consumption relative to the filtration approach illustrated and described in reference to FIGS. 2A-2B. Furthermore, those same features can also cause particle deposition on the disk surface, and this backflow filter approach completely eliminates that risk.

### MULTI-MODE RECIRCULATION FILTER

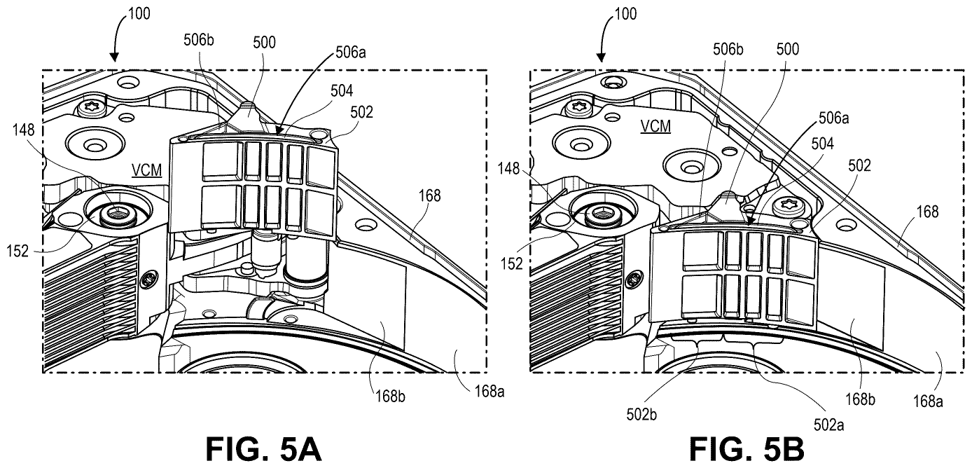

According to an embodiment, a recirculation filter combines the most effective attributes of the backflow concept and the spoiler concept into a complimentary system that produces effective cleanup times and high filter efficiency with the HSA parked on the ramp (e.g., a first mode) and across the HSA stroke from outer diameter (OD) to inner diameter (ID) (e.g., a second mode). FIG. 5A is an exploded perspective view illustrating a multi-mode recirculation filter for an HDD, and FIG. 5B is a perspective view illustrating the installed multi-mode recirculation filter of FIG. 5A, both according to one or more embodiments. FIGS. 5A-5B illustrate a multi-mode recirculation filter relative to a conventional hard disk drive (HDD) 100 comprising disk media mounted on a spindle (not shown here; see, e.g., recording medium 120 of FIG. 1), a head slider housing a read-write transducer (not shown here; see, e.g., slider 110b that includes a magnetic read-write head 110a of FIG. 1) configured to read from and to write to a disk medium of the disk media, an actuator assembly (not shown here; see, e.g., voice coil 140 of the voice coil motor of FIG. 1) configured for moving the head slider about a pivot (see also, e.g., pivot shaft 148 with an interposed pivot bearing assembly 152 of FIG. 1) to access portions of the disk medium. These HDD components are housed in an enclosure including a base (not shown here; see, e.g., HDD housing 168 of FIG. 1).

According to an embodiment, a recirculation filter 500 (or simply “filter 500”) is positioned upstream (e.g., at the “7 o'clock” location) of and adjacent to the pivot, where the recirculation filter 500 comprises a housing 502 configured for housing filtration media 504, the housing 502 comprising a first portion (e.g., “backflow portion”) comprising a first plurality of ribs 502a having a first distance therebetween and extending from a disk-facing side of the housing 502 toward the filtration media 504, and a first portion 506a (e.g., “backflow portion”) of a plenum, including a closed back side, on an opposing side of the filtration media 504 behind the first plurality of ribs 502a. According to an embodiment, the enclosure 168 includes a disk shroud 168a upstream of the recirculation filter, the disk shroud 168a including a diverter portion 168b configured for directing gas flow into the first portion 506a of the plenum of the recirculation filter 500. With this approach, the oncoming flow from the disk stack is diverted, redirected by the diverter portion 168b of the disk shroud 168a to behind the filtration media 504 and into the enclosed (or “semi-enclosed”, as it is open to the second portion 506b) first portion 506a of the plenum at a relatively high pressure. The filter housing 502 geometry is designed such that pressure is reduced on the disk side of the filtration media 504 relative to the first portion 506a of the plenum side, which draws free particles into the filtration media 504 (e.g., mainly to the back side of the filtration media 504) at least in the area of the first plurality of ribs 502a. Generally, and as depicted in FIGS. 5A-5B, each of the first plurality of ribs 502a of the first portion of the housing 502 comprises a substantially planar outermost disk-facing surface, and the first plurality of ribs 502a is configured with a radius of curvature substantially equivalent to a radius of curvature of the disk media.

As illustrated and described in reference to recirculation filter 300 of FIGS. 3A-3B, an HDD such as HDD 100 further comprises an HSA coupled with the actuator assembly and housing the head slider. According to an embodiment, the first plurality of ribs 502a of the backflow portion of the housing 502 is configured, relative to the filtration media 504, to reduce pressure on the disk-facing side of the filter 500 while the HSA is parked on a load/unload (LUL) ramp (not shown here; see, e.g., load/unload ramp 190 of FIG. 1). Here too the vertical rib geometry on the front of the filter, i.e., the first plurality of ribs 502a, whose orientation (orthogonal to the fluid flow), height, and spacing exploit the Lid Driven Cavity Flow phenomenon, effectuate a reduction in pressure on the disk side. This reduction maximizes the pressure drop across the filter 500 mainly across the backflow portion comprising the first plurality of ribs 502a in conjunction with the closed back wall of the first portion 506a of the plenum, which is a principal objective of maximizing fluid and particle flow through the filtration media 504 while the HSA is parked on the LUL ramp.

Here also in the case of filter 500, the cavity floor (filtration media 504) and the walls (first plurality of ribs 502a of housing 502) are not likely precisely perpendicular, thus the goal through CFD is to optimize such that there is minimal pressure variation across the floor but not so small as to eliminate effective filter area. According to an embodiment, the first plurality of ribs 502a of the first portion of the housing 502 is configured such that the ratio of a distance between each rib of the first plurality of ribs 502a relative to a depth of those ribs 502a lies in a range of one (1) to four (4).

According to an embodiment, the housing 502 of filter 500 further comprises a second portion downstream of the first portion and thus closer to the pivot. The second portion comprises a second plurality of ribs 502b having a second distance therebetween, greater than the first distance between the first plurality of ribs 502a, and extending from the disk-facing side of the housing 502 toward the filtration media 504. Note that the first plurality of ribs 502a and the second plurality of ribs 502b may include a common rib as depicted in FIG. 5B. Note also that the second plurality of ribs 502b includes the most downstream and/or terminating structure depicted in FIGS. 5A-5B, which may also by appearance be considered a housing “wall” but for purposes of this description is referred to by its function as a “rib”. While the second plurality of ribs 502b is depicted here with only two ribs, note that the number of cavities and corresponding ribs of the second plurality of ribs 502b may vary from implementation to implementation, such as if additional rib(s) may be needed for purposes of structural rigidity, filtration media 504 containment, ease of manufacturing, and the like.

According to an embodiment, the second portion of recirculation filter 500 further comprises a second portion 506b of the plenum, including an open back side, on the opposing side of the filtration media 504 behind the second plurality of ribs 502b. According to an embodiment, the second portion of the housing 502 is configured to enable increased pressure on the disk-facing side of the of the recirculation filter 500 in conjunction with the stagnation pressure generated by the HSA arms while loaded onto the disk media. Similar in operation/functionality to the aforementioned spoiler approach of spoiler 202 of FIGS. 2A-2B, with this multi-mode approach the pressure is increased on the disk side as the HSA moves from OD to ID because the arms of the HSA effectively build high pressure forcing particles to/through the filtration media 504 from the disk, and whereby the absence of a full back wall (e.g., an open-backed plenum) enables the flow to push outward from the disk stack and expand into the voice coil motor (VCM) cavity.

With a multi-mode recirculation filter such as filter 500, it is likely that particles are captured on both sides of the filtration media 504. This is because at times (i.e., HSA parked on the ramp in one mode) the first backflow portion is operationally predominant as the majority of the flow through the filtration media 504 is from back (plenum) to front (disk) and with less of an HSA influence, while at other times (i.e., HSA loaded onto disk stack in another mode) the second downstream portion is operationally predominant as the majority of the flow through the filtration media 504 is from front to back with more of an HSA influence.

However, one potential disadvantage of the use of the first and second plurality of ribs 502a, 502b for the purposes described herein is the reduction in effective filtration area due to the presence of vertical ribs blocking the incoming flow at the disk-facing side. One approach includes minimizing the width of such ribs (e.g., within manufacturing capabilities, tolerances) and/or maximizing the distance between and thus the open area between adjacent ribs (e.g., “window”) corresponding to the second portion of the filter 500.

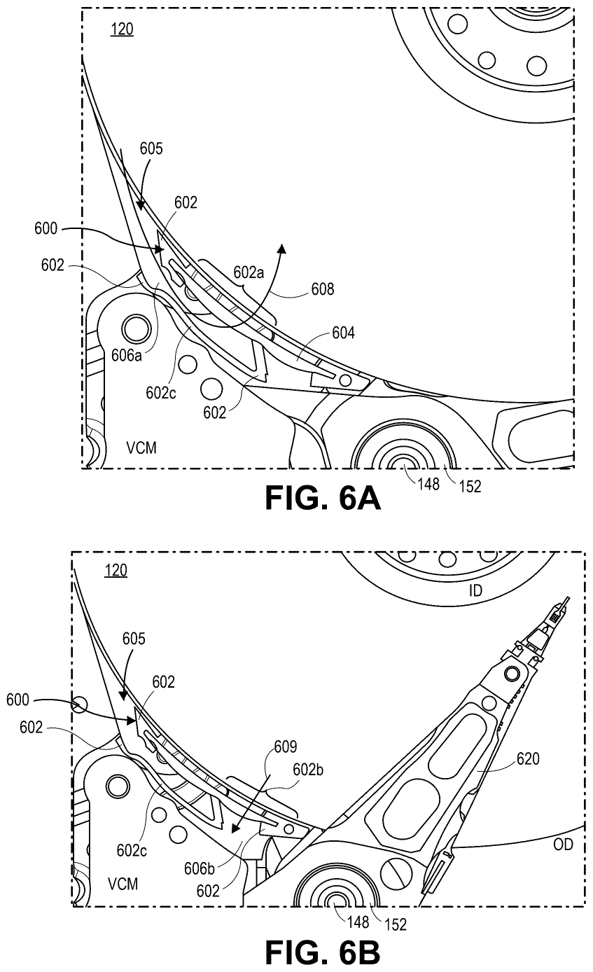

FIG. 6A is a top view illustrating functionality of a multi-mode recirculation filter with head stack assembly (HSA) parked on the load/unload ramp, according to an embodiment. As with filter 500 (FIGS. 5A-5B), according to an embodiment recirculation filter 600 (or simply “filter 600”) is positioned upstream (e.g., at the “7 o'clock” location) of and adjacent to the pivot, where the recirculation filter 600 comprises a housing 602 configured for housing a filtration media 604. The housing 602 comprises a first portion (e.g., “backflow portion”) comprising a first plurality of ribs 602a having a first distance therebetween and extending from a disk-facing side of the housing 602 toward the filtration media 604, and a first portion 606a (e.g., “backflow portion”) of a plenum, including a closed back side 602c, on an opposing side of the filtration media 604 behind the first plurality of ribs 602a. According to an embodiment, filter 600 further comprises a supply flow path 605 (e.g., an inlet, a scoop) configured for receiving gas flow directed into the first portion 606a of the plenum of the recirculation filter 600. With this approach, the oncoming flow from the disk stack is directed to behind the filtration media 604 and into the enclosed (or “semi-enclosed”, as it is open to the second portion 606b) first portion 606a of the plenum at a relatively high pressure.

Here also the filter housing 602 geometry, i.e., the geometry of the first plurality of ribs 602a on the front of the filter housing 602 relative to the filtration media 604, is configured to exploit the Lid Driven Cavity Flow phenomenon to effectuate a reduction in pressure on the disk side of the filtration media 604 relative to the first portion 606a of the plenum side of the filter 600 primarily while the HSA is parked on a LUL ramp (not shown here; see, e.g., load/unload ramp 190 of FIG. 1). Thus, free particles are drawn into the filtration media 604, e.g., mainly to the back side of the filtration media 604 from the first portion 606a of the plenum, as depicted by flow arrow 608. Flow arrow 608 generally represents the operation/functionality of the backflow portion of filter 600, as described in more detail in reference to filter 500. According to an embodiment, the first plurality of ribs 602a of the first portion of the housing 602 is configured such that the ratio of a distance between each rib of the first plurality of ribs 602a relative to a depth of those ribs 602a lies in a range of one (1) to four (4).

FIG. 6B is a top view illustrating functionality of the multi-mode recirculation filter of FIG. 6A with HSA loaded on the disk, according to an embodiment. According to an embodiment, the housing 602 of filter 600 further comprises a second portion downstream of the first portion and thus closer to the pivot shaft 148/bearing assembly 152. The second portion comprises a second plurality of ribs 602b having a second distance therebetween greater than the first distance between the first plurality of ribs 602a and extending from the disk-facing side of the housing 602 toward the filtration media 604. Note that the first plurality of ribs 602a and the second plurality of ribs 602b may include a common rib. Note also that the second plurality of ribs 602b includes the most downstream and/or terminating structure depicted in FIGS. 6A-6B, which may also by appearance be considered a housing “wall” but for purposes of this description is referred to by its function as a “rib”. While the second plurality of ribs 602b is depicted here with only two ribs, note that the number of cavities and corresponding ribs of the second plurality of ribs 602b may vary from implementation to implementation, such as if additional rib(s) may be needed for purposes of structural rigidity, filtration media 604 containment, ease of manufacturing, and the like. According to an embodiment, the second portion of recirculation filter 600 further comprises a second portion 606b of the plenum including an open back side on the opposing side of the filtration media 604 behind the second plurality of ribs 602b, whereby the open-backed plenum enables the flow to push outward from the disk stack and expand into the VCM cavity.

Here also the second portion of the housing 602 is configured to enable increased pressure on the disk-facing side of the of the recirculation filter 600 in conjunction with the stagnation pressure generated by the HSA 620 arms while loaded onto the disk medium/media 120, as depicted by flow arrow 609. Flow arrow 609 generally represents the operation/functionality of this second (e.g., spoiler) portion of filter 600 which capitalizes on the HSA-generated stagnation pressure. With this spoiler portion of the multi-mode approach, the pressure is increased on the disk side as the HSA moves from OD to ID because the arms of the HSA 620 effectively build high pressure forcing particles to/through the filtration media 604 from the disk stack through the filtration media 604 and into the VCM cavity.

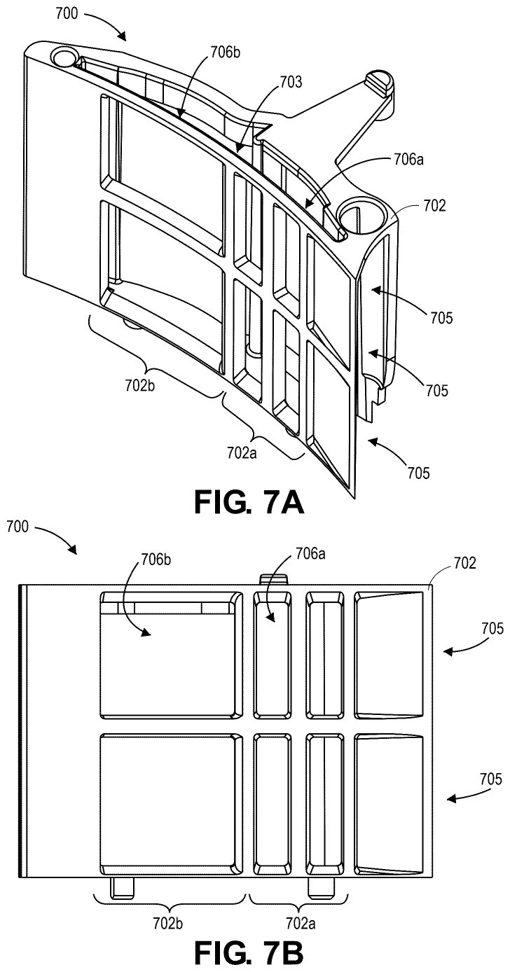

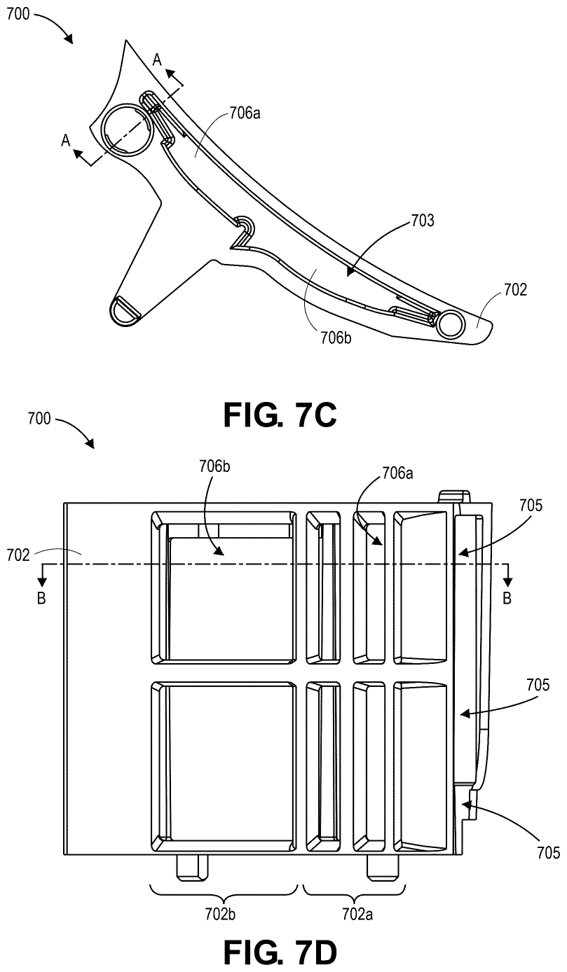

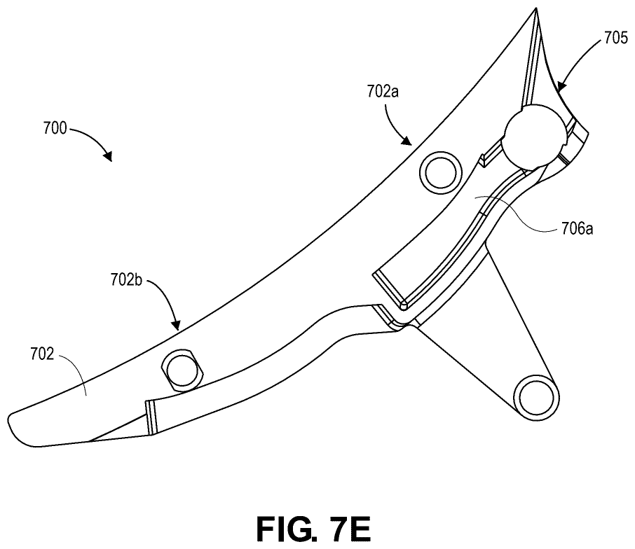

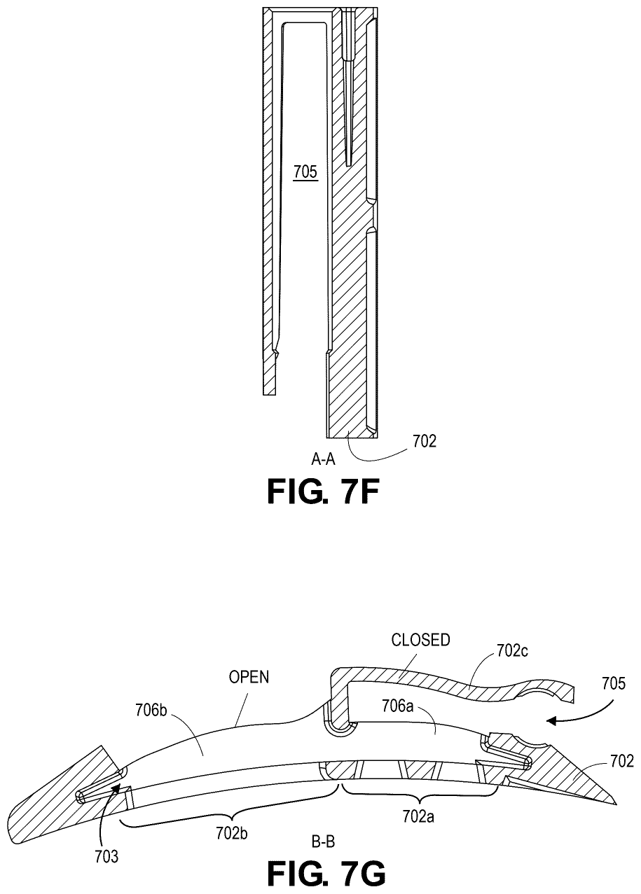

FIG. 7A is a perspective view illustrating a multi-mode recirculation filter, FIG. 7B is a front view illustrating the multi-mode recirculation filter of FIG. 7A, FIG. 7C is a top view illustrating the multi-mode recirculation filter of FIG. 7A, FIG. 7D is a side view illustrating the multi-mode recirculation filter of FIG. 7A, and FIG. 7E is a bottom view illustrating the multi-mode recirculation filter of FIG. 7A, all according to one or more embodiments. The multi-mode recirculation filter 700 (or simply “filter 700”) is illustrated in detail views FIGS. 7A-7G to provide more, and more precise, visual clarity and is configured slightly different (e.g., fewer ribs 702a) from the filter 500 of FIGS. 5A-5B. However, the description corresponding to filter 500 is largely further applicable to filter 700.

Recirculation filter 700 is configured for positioning upstream (e.g., at the “7 o'clock” location) of and adjacent to the pivot (see, e.g., pivot shaft 148/bearing assembly 152 of FIG. 1). According to an embodiment, filter 700 comprises a housing 702 configured for housing a filtration media (not shown here for clarity; see, e.g., filtration media 504 of FIGS. 5A-5B), where the housing 702 comprises a first portion (e.g., “backflow portion”) comprising a first plurality of ribs 702a having a first distance therebetween and extending from a disk-facing side of the housing 702 toward a filtration media cavity 703 (or simply “filter cavity 703”) and a first portion 706a (e.g., “backflow portion”) of a plenum, including a closed back side, on an opposing side of the filter cavity 703 behind the first plurality of ribs 702a. According to an embodiment, filter 700 further comprises a supply flow path 705 (e.g., an inlet, a scoop) configured for receiving gas flow directed into the first portion 706a of the plenum of the recirculation filter 700. For example, a corresponding HDD enclosure (see, e.g., housing 168 of FIG. 1) would include a disk shroud (see, e.g., disk shroud 168a of FIGS. 5A-5B) upstream of an installed recirculation filter 700, where the disk shroud 168a includes a diverter portion (see, e.g., diverter portion 168b of FIGS. 5A-5B) configured for directing gas flow into the first portion 706a of the plenum of the recirculation filter 700. With this approach, the oncoming flow from the disk stack is diverted, redirected to behind the filter cavity 703 and into the enclosed (or “semi-enclosed”, as it is open to the second portion 706b) first portion 706a of the plenum at a relatively high pressure. The filter housing 702 geometry is designed such that pressure is reduced on the disk side of the filtration media relative to the first portion 706a of the plenum side, which draws free particles into the filtration media (e.g., mainly to the back side of the filtration media) at least in the area of the first plurality of ribs 702a. Generally, and as depicted, according to an embodiment each of the first plurality of ribs 702a of the first portion of the housing 702 comprises a substantially planar outermost disk-facing surface, and the first plurality of ribs 702a is configured with a radius of curvature substantially equivalent to a radius of curvature of the disk media.

According to an embodiment, the housing 702 of filter 700 further comprises a second portion downstream of the first portion and thus closer to the pivot. The second portion comprises a second plurality of ribs 702b, having a second distance therebetween greater than the first distance between the first plurality of ribs 702a, and extending from the disk-facing side of the housing 702 toward the filter cavity 703. Note here also that the first plurality of ribs 702a and the second plurality of ribs 702b may include a common rib as illustrated. Note also that the second plurality of ribs 702b includes the most downstream and/or terminating structure depicted in FIGS. 7A-7E, which may also by appearance be considered a housing “wall” but for purposes of this description is referred to by its function as a “rib”. While the second plurality of ribs 702b is depicted here with only two ribs, note that the number of cavities and corresponding ribs of the second plurality of ribs 702b may vary from implementation to implementation, such as if additional rib(s) may be needed for purposes of structural rigidity, filtration media containment, ease of manufacturing, and the like. According to an embodiment, the second portion of recirculation filter 700 further comprises a second portion 706b of the plenum, including an open back side, on the opposing side of the filter cavity 703 behind the second plurality of ribs 702b. According to an embodiment, the second portion of the housing 702 is configured to enable increased pressure on the disk-facing side of the of the recirculation filter 700 in conjunction with the pressure generated by corresponding HSA arms of an HDD while loaded onto the disk media. With this multi-mode approach, the pressure is increased on the disk side as the HSA moves from OD to ID because the arms of the HSA effectively build high pressure forcing particles to/through the filtration media from the disk side, and whereby the absence of a full back wall (e.g., an open-backed plenum) enables the flow to push outward from the disk stack and expand into a VCM cavity of the corresponding HDD.

FIG. 7F is a cross-sectional view A-A illustrating the multi-mode recirculation filter of FIG. 7A, according to an embodiment. With reference to cut A-A of FIG. 7C, cross-sectional view A-A further illustrates the flow path 705 configured for receiving gas flow directed into the plenum of the recirculation filter 700, such as by a corresponding upstream diverter portion 168b of a disk shroud 168a of an HDD in which a filter such as filter 700 is intended to be installed. As described, the oncoming flow from the disk stack is redirected to behind the filter cavity 703 and into the first portion 706a of the plenum.

FIG. 7G is a cross-sectional view B-B illustrating the multi-mode recirculation filter of FIG. 7A, according to an embodiment. With reference to cut B-B of FIG. 7D, cross-sectional view B-B further illustrates the flow path 705 into the closed-back first portion 706a of the plenum which is backed by back wall 702c. This view further illustrates the second portion 706b of the plenum including an open back side which is open to a VCM cavity (see, e.g., FIGS. 6A-6B) in which a filter such as filter 700 is intended to be installed.

Techniques are described for improving the gas filtration in an HDD, at least in part by creating a pressure difference across a filtration medium whereby gas in the area of relatively greater pressure flows through particle filtration media to an area of relatively lesser pressure, thereby removing airborne particles from the flow within the enclosure of the HDD. Furthermore, a single multi-mode recirculation filter unit as illustrated and described herein, e.g., filter 600 (FIGS. 6A-6B), filter 700 (FIGS. 7A-7E), exploits the Lid Driven Cavity Flow phenomenon to effectuate a reduction in pressure on the disk side primarily while the HSA is parked on the load/unload ramp (e.g., one mode) and relies on the close proximity to the pressure generated by the HSA arms to effectuate an increase in pressure on the disk side primarily while the HSA is loaded onto a disk stack (e.g., another mode). Thus, such a recirculation filter is effective in forcing airborne particles to a filtration media for capturing such particles across the full spectrum of operation of an HDD generally and the HSA more particularly.

### PHYSICAL DESCRIPTION OF AN ILLUSTRATIVE OPERATING CONTEXT

Embodiments may be used in the context of a digital data storage device (DSD) such as a hard disk drive (HDD). Thus, in accordance with an embodiment, a plan view illustrating a conventional HDD 100 is shown in FIG. 1 to aid in describing how a conventional HDD typically operates.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110 to access portions of the medium 120, all collectively mounted on a pivot shaft 148 with an interposed pivot bearing assembly 152. In the case of an HDD having multiple disks, the carriage 134 may be referred to as an E-block, and/or a comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations. The HSA is configured to mechanically interact with a load/unload (LUL) ramp 190 to move the head stack assembly (HSA), including the read-write head sliders, away from and off the disks and to safely position them onto the supporting structure of the LUL ramp.

With further reference to FIG. 1, electrical signals (e.g., current to the voice coil 140 of the VCM) comprising a write signal to and a read signal from the head 110a, are transmitted by a flexible cable assembly (FCA) 156 (also referred to as a “flex cable” and/or “flexible printed circuit” (FPC)). Interconnection between the flex cable 156 and the head 110a may include an arm-electronics (AE) module 160, which may have an on-board pre-amplifier for the read signal, as well as other read-channel and write-channel electronic components. The AE module 160 may be attached to the carriage 134 as shown. The flex cable 156 may be coupled to an electrical-connector block 164, which provides electrical communication, in some configurations, through an electrical feed-through provided by an HDD housing 168. The HDD housing 168 (also referred to as an “enclosure base” and/or “baseplate” and/or simply “base”), in conjunction with an HDD cover, provides a semi-sealed (or hermetically sealed, in some configurations) protective enclosure for the information storage components of the HDD 100.

Other electronic components, including a disk controller and servo electronics including a digital-signal processor (DSP), provide electrical signals to the drive motor, the voice coil 140 of the VCM, and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (also referred to as a “track sector”) such as sectored track portion 188. Each sectored track portion 188 may include recorded information, and a header containing error correction code information and a servo-burst-signal pattern, such as an ABCD-servo-burst-signal pattern, which is information that identifies the track 176. In accessing the track 176, the read element of the head 110a of the HGA 110 reads the servo-burst-signal pattern, which provides a position-error-signal (PES) to the servo electronics, which controls the electrical signal provided to the voice coil 140 of the VCM, thereby enabling the head 110a to follow the track 176. Upon finding the track 176 and identifying a particular sectored track portion 188, the head 110a either reads information from the track 176 or writes information to the track 176 depending on instructions received by the disk controller from an external agent, for example, a microprocessor of a computer system.

An HDD's electronic architecture comprises numerous electronic components for performing their respective functions for operation of an HDD, such as a hard disk controller (HDC), an interface controller, an arm electronics module, a data channel, a motor driver, a servo processor, buffer memory, etc. Two or more of such components may be combined on a single integrated circuit board referred to as a “system on a chip” (SOC). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass an information storage device that is at times referred to as a hybrid drive. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differ, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### EXTENSIONS AND ALTERNATIVES

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps and are not intended to specify or require a particular order of carrying out such steps.

What is claimed is:

1. A hard disk drive (HDD) comprising:
disk media mounted on a spindle;
a head slider housing a read-write transducer configured to read from and to write to a disk medium of the disk media;
an actuator assembly configured for moving the head slider about a pivot to access portions of the disk medium;
a recirculation filter positioned upstream of and adjacent to the pivot, the recirculation filter comprising:
a housing configured for housing filtration media, the housing comprising a first portion comprising a first plurality of ribs, having a first distance therebetween, extending from a disk-facing side of the housing toward the filtration media, and
a first portion of a plenum, including a closed back side, on an opposing side of the filtration media behind the first plurality of ribs; and
an enclosure comprising a disk shroud upstream of the recirculation filter, the disk shroud including a diverter portion configured for directing gas flow into the plenum.

2. The HDD of claim 1, further comprising a head stack assembly (HSA) coupled with the actuator assembly and housing the head slider, wherein the first plurality of ribs of the first portion of the housing is configured, relative to the filtration media, to reduce pressure on the disk-facing side of the recirculation filter while the HSA is parked on a load/unload ramp.

3. The HDD of claim 1, wherein the first plurality of ribs of the first portion of the housing is configured such that a ratio of a distance between each rib of the first plurality of ribs relative to a depth of those ribs lies in a range of one to four.

4. The HDD of claim 1, wherein the recirculation filter further comprises a supply flow path configured for receiving gas flow directed into the plenum.

5. The HDD of claim 1, wherein:
each of the first plurality of ribs of the first portion of the housing comprises a substantially planar outermost disk-facing surface; and
the first plurality of ribs is configured with a radius of curvature substantially equivalent to a radius of curvature of the disk media.

6. The HDD of claim 1, wherein:
the housing further comprises a second portion downstream of the first portion, the second portion comprising a second plurality of ribs, having a second distance therebetween greater than the first distance between the first plurality of ribs, extending from the disk-facing side of the housing toward the filtration media; and
the recirculation filter further comprises a second portion of the plenum, including an open back side, on the opposing side of the filtration media behind the second plurality of ribs.

7. The HDD of claim 6, further comprising a head stack assembly (HSA) coupled with the actuator assembly and housing the head slider, wherein the second portion of the housing of the recirculation filter is configured to increase pressure on the disk-facing side of the recirculation filter in conjunction with the HSA while loaded onto the disk media.

8. The HDD of claim 1, wherein the recirculation filter is positioned within the enclosure at a 7 o'clock location.

9. A recirculation filter for a hard disk drive (HDD), the recirculation filter comprising:
filtration media;
a housing configured for housing the filtration media, the housing comprising a first portion comprising a first plurality of ribs, having a first distance therebetween, extending from a disk-facing side of the housing toward the filtration media;
a first portion of a plenum, including a closed back side, on an opposing side of the filtration media behind the first plurality of ribs; and
a supply flow path for receiving flow into the plenum.

10. The recirculation filter of claim 9, wherein the first plurality of ribs of the first portion of the housing is configured, relative to the filtration media, to reduce pressure on the disk-facing side of the recirculation filter in a first mode of operation.

11. The recirculation filter of claim 9, wherein the first plurality of ribs of the first portion of the housing is configured such that a ratio of a distance between each rib of the first plurality of ribs relative to a depth of those ribs lies in a range of one to four.

12. The recirculation filter of claim 9, wherein:
the housing further comprises a second portion downstream of the first portion, the second portion comprising a second plurality of ribs, having a second distance therebetween greater than the first distance between the first plurality of ribs, extending from the disk-facing side of the housing toward the filtration media; and
the recirculation filter further comprises a second portion of the plenum, including an open back side, on the opposing side of the filtration media behind the second plurality of ribs.

13. The recirculation filter of claim 12, wherein the second portion of the housing of the recirculation filter is configured to increase pressure on the disk-facing side of the recirculation filter in conjunction with a head stack assembly (HSA) while loaded onto the disk media.

14. A hard disk drive comprising the recirculation filter of claim 12.

15. A hard disk drive (HDD) comprising:
disk media rotatably mounted on a spindle;
means for reading from and writing to a disk medium of the disk media;
means for moving the head slider about a pivot to access portions of the disk medium;
a recirculation filter positioned upstream of and adjacent to the pivot, the recirculation filter comprising:
a housing configured for housing filtration media, the housing comprising a first portion comprising a first plurality of ribs, having a first distance therebetween, extending from a disk-facing side of the housing toward the filtration media, and
a first portion of a plenum, including a closed back side, on an opposing side of the filtration media behind the first plurality of ribs; and
an enclosure comprising a disk shroud upstream of the recirculation filter, the disk shroud including means for directing gas flow into the plenum.

16. The HDD of claim 15, further comprising a head stack assembly (HSA) coupled with the means for moving and housing the means for reading and writing, wherein the first plurality of ribs of the first portion of the housing of the recirculation filter is configured, relative to the filtration media, to reduce pressure on the disk-facing side of the recirculation filter while the HSA is parked on a load/unload ramp.

17. The HDD of claim 15, wherein the first plurality of ribs of the first portion of the housing of the recirculation filter is configured such that a ratio of a distance between each rib of the first plurality of ribs relative to a depth of those ribs lies in a range of one to four.

18. The HDD of claim 15, wherein:
the housing of the recirculation filter further comprises a second portion downstream of the first portion, the second portion comprising a second plurality of ribs, having a second distance therebetween greater than the first distance between the first plurality of ribs, extending from the disk-facing side of the housing toward the filtration media; and
the recirculation filter further comprises a second portion of the plenum, including an open back side, on the opposing side of the filtration media behind the second plurality of ribs.

19. The HDD of claim 18, further comprising a head stack assembly (HSA) coupled with the means for moving and housing the means for reading and writing, wherein the second portion of the housing of the recirculation filter is configured to increase pressure on the disk-facing side of the recirculation filter in conjunction with the HSA while loaded onto the plurality of disk media.

20. The HDD of claim 15, wherein the recirculation filter is positioned within the enclosure at a 7 o'clock location.
